(19) United States
(12) Patent Application Publication
(10) Pub. No.: US 2025/0358726 A1
(43) Pub. Date: Nov. 20, 2025

(54) TECHNIQUES FOR INDIRECT NETWORK SHARING

(71) Applicant: Lenovo (Singapore) Pte. Ltd., New Tech Park (SG)

(72) Inventor: Genadi Velev, Darmstadt (DE)

(21) Appl. No.: 18/667,865

(22) Filed: May 17, 2024

(51) Int. Cl. H04W 48/18; H04W 8/12; H04W 84/04

(52) U.S. Cl. CPC H04W 48/18; H04W 8/12; H04W 84/042

(57) ABSTRACT

Various aspects of the present disclosure relate to techniques for indirect network sharing. A network entity is configured to receive a first message from a second network entity of a hosting network to provide network slice configuration information for a UE of a participating network associated with the hosting network. The first message includes assistance information. The network entity is configured to transmit a second message to the second network entity that includes the network slice configuration information. The network slice configuration information includes one or more of an allowed NSSAI, a configured NSSAI, or a list of rejected S-NSSAIs, wherein the allowed NSSAI, the configured NSSAI, or the rejected S-NSSAIs include S-NSSAIs of the participating network.

### TECHNICAL FIELD

The present disclosure relates to wireless communications, and more specifically to techniques for indirect network sharing.

### BACKGROUND

A wireless communications system may include one or multiple network communication devices, such as base stations (BSs), which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A network entity is configured to receive a first message from a second network entity of a hosting network to provide network slice configuration information for a UE of a participating network associated with the hosting network. The first message includes assistance information. The network entity is configured to transmit a second message to the second network entity that includes the network slice configuration information. The network slice configuration information includes one or more of an allowed network slice selection assistance information (NSSAI), a configured NSSAI, or a list of rejected S-NSSAIs, wherein the allowed NSSAI, the configured NSSAI, or the rejected S-NSSAIs include S-NSSAIs of the participating network.

### BRIEF DESCRIPTION OF THE DRAWINGS

FIG. 1 illustrates an example of a wireless communications system in accordance with aspects of the present disclosure.

FIG. 2 illustrates an example architecture of 5G Multi-Operator Core Networks (5G MOCN), in accordance with aspects of the present disclosure.

FIG. 3 illustrates an example of an indirect network sharing architecture, in accordance with aspects of the present disclosure.

FIG. 4 illustrates an example of a roaming architecture for home routed scenario in service-based interface representation, in accordance with aspects of the present disclosure.

FIG. 5 illustrates an indirect network sharing architecture, in accordance with aspects of the present disclosure.

FIG. 6 illustrates an example signaling diagram for requesting network slice configuration information, in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of a network equipment (NE) in accordance with aspects of the present disclosure.

FIG. 10 illustrates a flowchart of a method performed by a device in accordance with aspects of the present disclosure.

FIG. 11 illustrates a flowchart of a method performed by a device in accordance with aspects of the present disclosure.

### DETAILED DESCRIPTION

A wireless communication network supporting one or more radio access technologies, such as 5G may support network slicing to provide for one or more network slices. A network slice is a logical network that includes of a set of network functions and resources (e.g., computing, storage, networking) for providing network capabilities and network characteristics. A network slice can include a core network (e.g., a 5G core network (5GC)) control plane and one or more user plane network functions (NFs), an access network (AN) (e.g., 5G radio access network (RAN) or a fixed AN). As such, network slicing may enable network operators to divide (“slice”) the wireless communication network into a finer granularity of networks referred to as network slices. These network slices may support (e.g., provide) network connectivity (or network features) for users (e.g., customers) or services provides (e.g., applications, services, etc.).

One or more network entities (e.g., network functions) or base setations may configure a UE with relevant network slice information (also referred to as NSSAI). The NSSAI may include one or more single NSSAIs (S-NSSAIs). The UE may request to register to one or more network slices by transmitting a non-access stratum (NAS) registration request message to a network entity (e.g., an access and mobility management function (AMF)) of a core network (e.g., the 5GC), including a requested NSSAI containing a set (e.g., list) of one or more S-NSSAIs to which the UE is requesting to register. The network entity (e.g., AMF) may output (e.g., transmit) to the UE a registration accept message, which may include information associated with a network slice configuration for the UE. The information may include allowed NSSAI, a mapping of the allowed NSSAI to one or more home public land mobile network (HPLMN) S-NSSAI values (e.g., in case of roaming), a configured NSSAI, a mapping of the configured NSSAI to the one or more HPLMN S-NSSAI values (e.g., in case of roaming), rejected NSSAI, or pending NSSAI. Additionally, or alternatively, the information may be included in a UE configuration update command message. The NSSAI may include a list of one or more S-NSSAIs.

A configured NSSAI for a PLMN that is different from a default configured NSSAI created at a unified data management (UDM) may be provided by a serving AMF and valid for a serving PLMN. For example, when a UE is roaming, the serving AMF and/or a network slice selection function (NSSF) in a VPLMN may create (e.g., determine, select, identify, generate) a configured NSSAI for the UE and the VPLMN based on one or more subscribed S-NSSAIs associated with the UE. The configured NSSAI may include a mapping of configured NSSAI, which includes a mapping (e.g., association) between S-NSSAIs of the VPLMN and S-NSSAIs of a HPLMN.

More information about network slices and 5GS can be found in 3GPP TS 23.501, V18.5.0, 2024-03 (incorporated herein by reference) and 3GPP TS 23.502, V18.5.0, 2024-03 (incorporated herein by reference).

Indirect network sharing may be based on a roaming architecture, in which a hosting network may function (e.g., operate) as a VPLMN and a participating network may function (e.g., operate) like a HPLMN. Traffic (e.g., PDUs) of a UE may be forwarded to the participating network by using home routed PDU session(s) (where the PDU Session is supported by a session management function (SMF) under control of the HPLMN, by a SMF function under control of the VPLMN, by at least one user plane function (UPF) under control of the HPLMN and by at least one UPF under control of the VPLMN). However, some network slice configurations for roaming networks are not configured for roaming because the UE functions as connecting and registering to a home network, although the hosting network functions like a VPLMN. Accordingly, existing frameworks for network slicing support for roaming cannot be applied as-is and enhancements to the network behavior (e.g., VPLMN) are needed.

In one embodiment, this disclosure describes how the serving AMF, e.g., the AMF in the hosting MNO, determines the configured NSSAI for the participating network, e.g., including values of the participating network. An issue is that the serving AMF doesn't know whether the UE has already been provisioned with a configured NSSAI for the participating network. Even if the UE has been provisioned with a configured NSSAI for the participating network, the values of the configured NSSAI for the participating network may need to be updated and the serving AMF in the hosting network doesn't know the S-NSSAIs of the participating network.

In one embodiment for indirect network sharing, from the UE side, the UE in the area of the shared RAN selects a participating network and the UE registers with the participating network. The intermediate 5GC of the hosting network is transparent to the UE. Correspondingly, procedures from the UE side are the same as if the UE registers and communicates directly with the participating network. The participating network can be either a HPLMN or VPLMN for the UE. The hosting network's AMF (e.g., the serving AMF) needs to mimic an AMF behavior of the participating network's 5GC to the UE, e.g., the network slice configuration towards the UE is set in a way as if it comes from the participating network's 5GC. In one example, the participating network may not be the HPLMN of the UE. In other words, the participating network is a VPLMN. The subject matter herein describes how the UE can be provided with a configured NSSAI for the participating network when the AMF and V-NSSF are in the hosting network, which improves the efficient utilization of resources and improves the user experience for the UE.

Aspects of the present disclosure are described in the context of a wireless communications system.

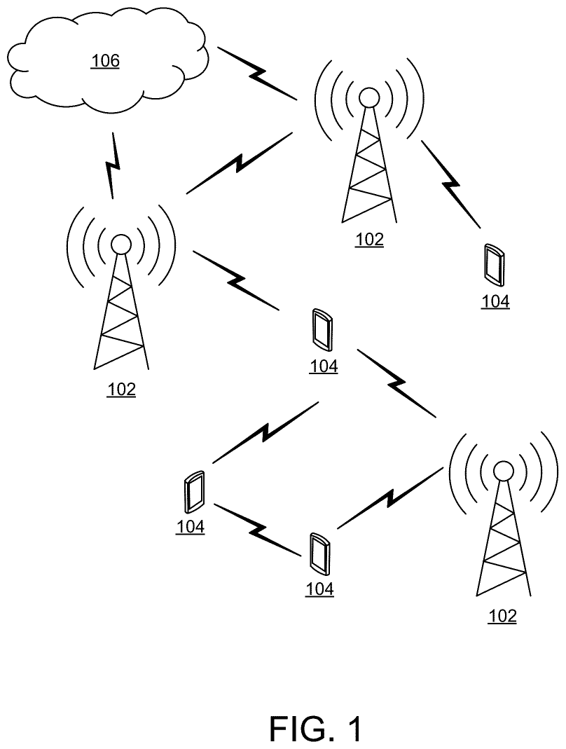

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmit-receive points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a UPF). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

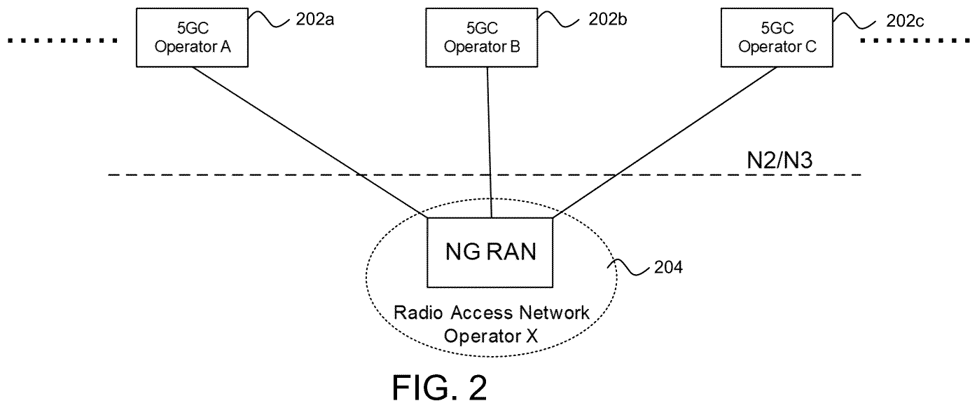

FIG. 2 illustrates an example architecture of 5G MOCNs, in accordance with aspects of the present disclosure. In one embodiment, the 5GS allows for sharing of resources or functionalities between different network operators 202a-c. The 5GS specifies that multiple participating network operators 202a-c (referred to as mobile network operators (MNOs)) can share resources of a single shared network according to agreed allocation schemes. The shared network, in one embodiment, includes a radio access network 204. One example is shown in FIG. 2 where the CNs (e.g. 5GCs) of operator A 202a, operator B 202b, and operator C 202c share RAN resources. This is known as 5G MOCN network sharing architecture where each core network (CN) of a participating operator is connected directly to the shared RAN.

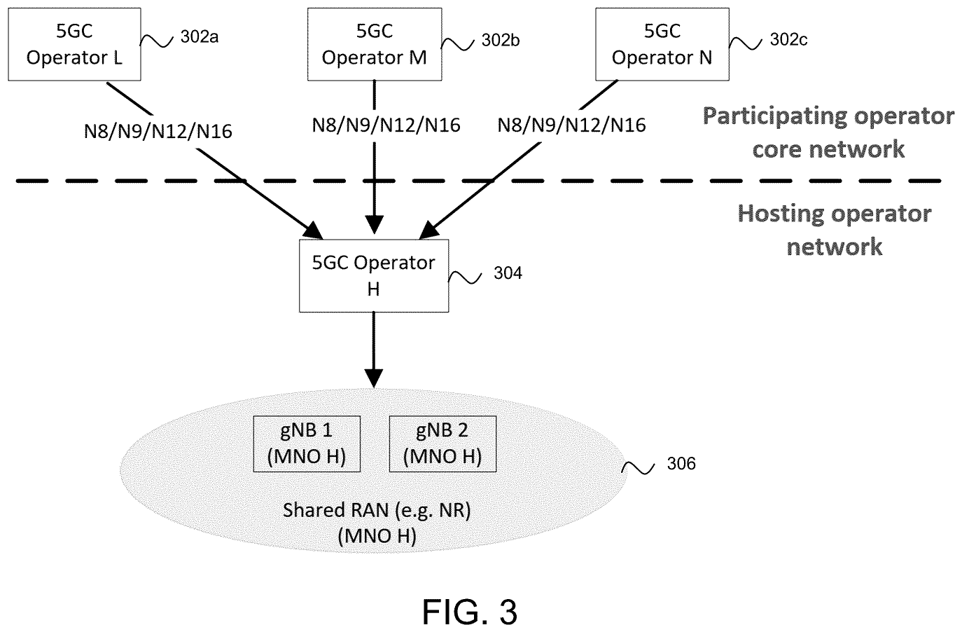

FIG. 3 illustrates an example of an indirect network sharing architecture, in accordance with aspects of the present disclosure. In one embodiment, indirect network sharing deployment between a hosting operator 304 (e.g., shared network operator) and one or more participating operators 302a-c may be supported. This is shown in FIG. 3 where a hosting operator “H” 304 shares its RAN and 5GC 306 to participating operators “L” 302a, “M” 302b, and “N” 302c. The communication between the shared RAN 306 and the core network of the participating operators “L” 302a, “M” 302b, and “N” 302c is routed through the core network of the hosting operator “H” 304 that connects to the shared RAN 306.

For indirect network sharing, the shared RAN 306 broadcasts multiple PLMN IDs, including the PLMN ID that represents the hosting operator 304 and the PLMN IDs that represent participating operators 302a-c. Multiple PLMN IDs are supported by the serving AMF (e.g., the AMF in the core network of the PLMN representing the hosting operator 304).

A UE from a participating operator 302a-c can select the PLMN ID representing the participating operator 302a-c in the shared RAN 306 area based on existing procedures. The serving AMF selects core network functions in the PLMN of the participating operator for the UE, based on home routed roaming architecture principles, e.g., see 3GPP TS 23.501, V18.5.0, 2024-03. In addition, the serving AMF selects the SMF of participating operator 302a-c possibly considering UE location information and also selects a V-SMF in its own network during the PDU session establishment procedure.

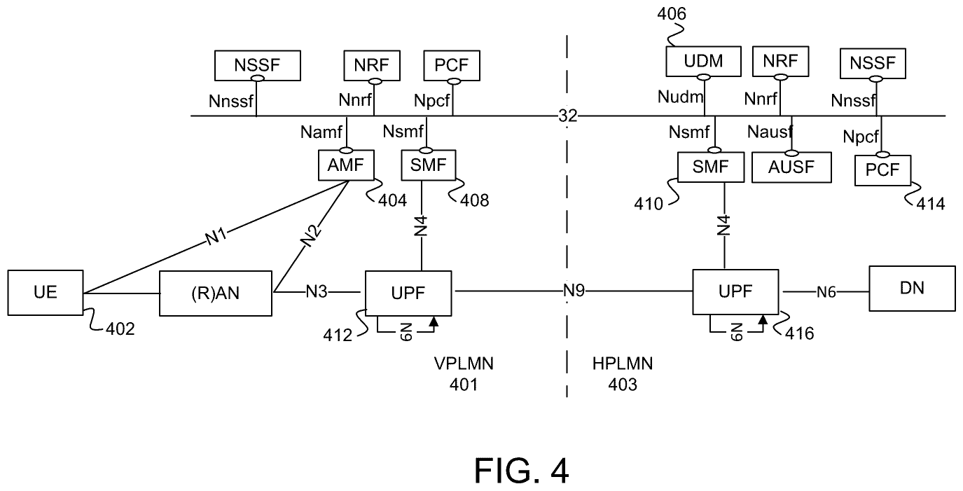

FIG. 4 illustrates an example of roaming architecture for home routed scenario in service-based interface representation, in accordance with aspects of the present disclosure. The UE 402 registers with the (serving) AMF 404 in the VPLMN 401. The AMF 404 retrieves the UE 402 subscription data from the UDM 406 in the HPLMN 403. When a home routed PDU Session is established, the AMF 404 in the VPLMN 401 selects both a) an SMF 408 in the VPLMN 401 called V-SMF and b) an SMF 410 in the HPLMN 403 called H-SMF. The AMF 404 forwards the PDU Session establishment request from the UE 402 to the V-SMF 408, which selects a UPF 412 in the VPLMN 401 and forwards the PDU Session establishment request to the H-SMF 410. The H-SMF 410 retrieves the PDU Session subscription data from the UDM 406, establishes SM policy association with the H-PCF 414, selects an anchor UPF 416 and sends a PDU Session establishment response (e.g., accept) message to the V-SMF 408.

With respect to the indirect network sharing, the roaming architecture shown in FIG. 4 applies when the hosting network is represented by the VPLMN and the participating network is represented by the HPLMN. However, from the UE perspective, the UE selects and registers with the participating network. In other words, the hosting network is transparent to the UE.

It is noted that this disclosure uses the term PLMN as an identifier for a public network, but the solutions may also apply to non-public networks, e.g. standalone non-public networks (SNPNs). In case of SNPN, the SNPN ID is used, and the PLMN ID can be interchangeably used as the SNPN ID.

It is also noted that the hosting network is identified by hosting network PLMN ID and the participating network is identified by participating network PLMN ID. Furthermore, the terms “hosting network”, “hosting operator” and “hosting network operator” are used interchangeably. Similarly, the terms “participating network”, “participating operator” and “participating network operator” are used interchangeably.

In one embodiment for indirect network sharing, from the UE side, the UE in the area of the shared RAN selects a participating operator and the UE registers with the participating operator. The intermediate 5GC of the hosting operator is transparent to the UE. Correspondingly, procedures from the UE side are the same as if the UE registers and communicates directly with the participating operator. The participating operator can be either a HPLMN or VPLMN for the UE. The hosting operator's AMF (e.g., the serving AMF) needs to mimic an AMF behavior of the participating operator's 5GC to the UE, e.g., the network slice configuration towards the UE is set in a way as if it comes from the participating operator's 5GC. In one example, the participating operator may not be the HPLMN of the UE. In other words, the participating operator is a VPLMN. In such a scenario, it is unclear how the UE can be provided with a configured NSSAI for the participating operator, because the AMF and V-NSSF are in the hosting network.

In one embodiment, this disclosure describes how the serving AMF, e.g., the AMF in the hosting MNO, determines the configured NSSAI for the participating network, e.g., including values of the participating network. An issue is that the serving AMF doesn't know whether the UE has already been provisioned with a configured NSSAI for the participating network. Even if the UE has been provisioned with a configured NSSAI for the participating network, the values of the configured NSSAI for the participating network may need to be updated and the serving AMF in the hosting network doesn't know the S-NSSAIs of the participating network.

In one embodiment, the following is based on FIGS. 3 and 4 above. In one embodiment, this disclosure describes how a (serving) AMF in the hosting network determines to request the NSSF in the hosting network (e.g., V-NSSF) to provide network slice configuration for the UE. The network slice configuration may include the configured NSSAI for the participating network operator. The AMF may determine to request the V-NSSF for the network slice configuration for the UE, e.g., for configured NSSAI for the participating network, based on a local configuration to request the V-NSSF, an indication for an ‘initial registration’ type in the registration request message, or an indication of using a default configured NSSAI for the requested NSSAI in the registration request message.

For a serving network function, e.g., AMF, in a hosting network operator, the AMF may determine that a UE registering with a participating operator may need to be provided with configured NSSAI, in addition to allowed NSSAI or partially allowed NSSAI. The AMF may send a request to the V-NSSF to provide the network slice configuration for the UE and the AMF may include an indication for the hosting network operator PLMN ID and the participating operator PLMN ID.

The AMF may receive from the V-NSSF an allowed NSSAI for the UE for the participating network (e.g., including S-NSSAIs of the participating network), and in case of a roaming UE, the mapping of the S-NSSAIs of the allowed NSSAI to the HPLMN S-NSSAIs. The AMF may receive from the V-NSSF configured NSSAI for the participating network (e.g., including S-NSSAIs of the participating network), and in case of a roaming UE, the mapping of the S-NSSAIs of the configured NSSAI to the HPLMN S-NSSAIS.

The AMF may receive from the V-NSSF excluded or rejected S-NSSAIs for the participating network, and in case of a roaming UE, the mapping of the rejected S-NSSAI of the participating operator to the HPLMN S-NSSAIs. The AMF may receive from the V-NSSF an allowed NSSAI for the hosting network, which includes the S-NSSAIs of the hosting network corresponding or mapping to the S-NSSAIs of the participating network from the allowed NSSAI.

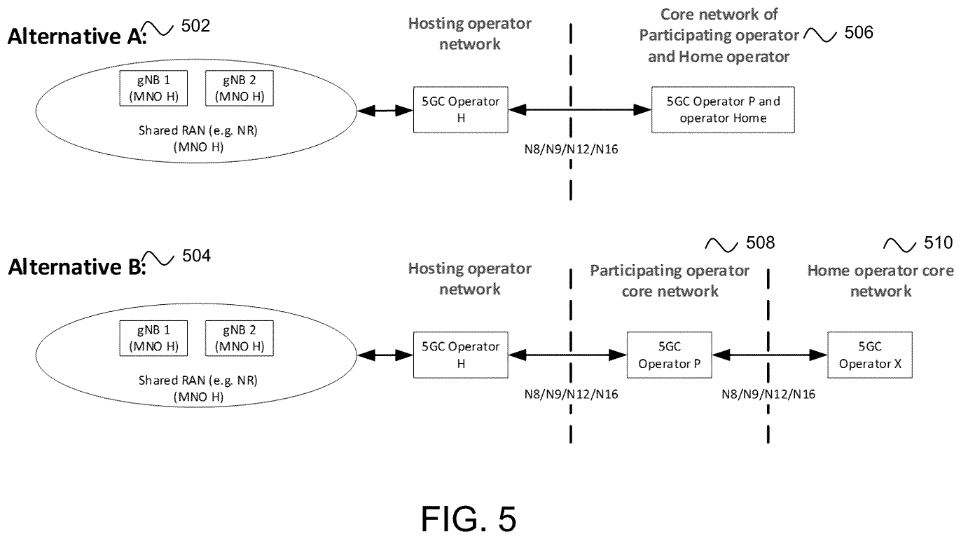

The AMF may provide to the UE the allowed NSSAI, and optionally the partially allowed NSSAI, for the UE and the configured NSSAI for the participating network PLMN ID. If the UE is registering for a non-roaming scenario, the AMF doesn't provide the mapping information of the S-NSSAIs of the participating network included in the allowed NSSA (or partially allowed NSSAI), rejected S-NSSAIs and configured NSSAI to the HPLMN S-NSSAIs (e.g. of the HPLMN operator). If the UE is registering for roaming case (e.g., see the description of the FIG. 5), the AMF provides the mapping information of the S-NSSAIs of the participating network included in allowed NSSA, partially allowed NSSAI, rejected S-NSSAIs, and/or configured NSSAI to the HPLMN S-NSSAIs (e.g., of the HPLMN network). In addition, the AMF may store in the UE context a list of mapped S-NSSAIs of the hosting network corresponding to the S-NSSAIs of the participating network included in the allowed NSSAI (or partially allowed NSSAI) or rejected S-NSSAIs sent to the UE. The “list of mapped S-NSSAIs of the hosting operator” may be referred to as the allowed NSSAI for the hosting network.

For an NSSF in the hosting network operator, e.g., V-NSSF, the V-NSSF receives a request (e.g., from the AMF) to provide network slice configuration for the UE, which may include a request indication to provide an allowed NSSAI and a configured NSSAI for the participating network, a request indication to provide for the S-NSSAIs of the hosting network corresponding or mapping to the S-NSSAIs included in the allowed NSSAI and/or configured NSSAI for the participating network. In addition, the AMF may provide the subscribed S-NSSAIs, requested NSSAI, current tracking area identity (TAI), PLMN ID of hosting network, and/or PLMN ID of the participating network.

The V-NSSF may discover (or select) an NSSF in the participating network (e.g., H-NSSF). The V-NSSF may request or query the H-NSSF for the network slice configuration for the UE of the participating network identified by the participating network PLMN ID. The request may include the subscribed S-NSSAIs for the UE.

The V-NSSF may receive (e.g., from the NSSF of the participating network, e.g. H-NSSF) one or more of the configured NSSAI for the participating network (e.g. including S-NSSAIs of the participating network), the mapping of the subscribed S-NSSAIs to the VPLMN S-NSSAIs of the participating network, rejected or excluded NSSAIs for the participating network (e.g., the S-NSSAIs not available or supported in the participating network), or the like.

The V-NSSF may determine one or more of a local configuration and/or information received from the NSSF of the participating network and local configuration. The configuration may include the allowed NSSAI for the UE includes the S-NSSAIs of the participating network. The V-NSSF may use at least one of the subscribed S-NSSAIs, the received configured NSSAI for the UE for the participating network, the mapping of the subscribed S-NSSAIs to the (VPLMN) S-NSSAIs of the participating network and/or the mapping of the (VPLMN) S-NSSAIs of the participating network to the S-NSSAIs of the hosting network. The V-NSSF may determine which S-NSSAIs of the hosting network are available or supported in the current UE's TAI. The V-NSSF may use the available or supported S-NSSAIs of the hoisting network and maps them to the S-NSSAIs of the participating network. The V-NSSF may create the allowed NSSAI for the UE by including the S-NSSAIs of the participating network (which corresponds or maps to the S-NSSAIs of the hosting network available or supported in the current TAI). In case of a roaming UE, the NSSF provides the mapping of the S-NSSAIs of the allowed NSSAI for the UE to the HPLMN S-NSSAIs.

Additionally, the configuration may include the configured NSSAI for the participating network (e.g., including S-NSSAIs of the participating network) may be created based on internal configuration in V-NSSF. In case of roaming UE, the NSSF provides the mapping of the S-NSSAIs of the configured NSSAI for the UE to the HPLMN S-NSSAIS.

Further, the configuration may include the allowed NSSAI for the hosting network (or partially allowed NSSAI for the hosting network), e.g., containing S-NSSAI values of the hosting network mapping to the S-NSSAI values of the participating network. The allowed NSSAI for the hosting network (or partially allowed NSSAI for the hosting operator) may be used internally in the hosting network. The allowed NSSAI for the hosting network may be stored locally in the AMF and may correspond to the “Mapping Of Allowed NSSAI” that includes a mapping of each S-NSSAI of the participating network to S-NSSAI of the hosting network.

Moreover, the configuration may include a list of one or more rejected or excluded S-NSSAIs of the participating network. In case of a roaming UE, the NSSF provides the mapping of the rejected S-NSSAIs of the participating network to the HPLMN S-NSSAIs.

For an NSSF in the participating network, e.g., H-NSSF, the H-NSSF receives a request (e.g. from the V-NSSF) to provide network slice configuration for the UE for the participating network, wherein the request may include at least one of the participating network PLMN ID or the subscribed S-NSSAIs.

The H-NSSF may determine a configured NSSAI for the participating network (e.g., including S-NSSAIs of the participating network), and, in case the participating network acts as VPLMN for the UE, the mapping of the S-NSSAIs of the configured NSSAI of the participating network to the subscribed S-NSSAIs (e.g., the H-PLMN S-NSSAIs). The H-NSSF may consider the subscribed S-NSSAIs of the UE, the S-NSSAIs of the participating operator corresponding to the subscribed S-NSSAIs, and/or the supported S-NSSAIs of the participating network.

The H-NSSF may send to the V-NSSF the configured NSSAI for the participating network (e.g., including S-NSSAIs of the participating network) and the mapping of the S-NSSAIs of the configured NSSAI of the participating network to the subscribed S-NSSAIs (e.g., the H-PLMN S-NSSAIs).

The Subscription Permanent Identifier (SUPI) of the UE may consist of two parts-the PLMN ID of the home network (e.g., the operator ID that assigns the UE SIM profile) and the Mobile Subscriber Identification Number (MSIN) that identifies the mobile subscription within a PLMN. During a registration procedure, the AMF may determine whether the UE is registering for roaming or for non-roaming case. The AMF may consider the PLMN ID of the SUPI and compares it with the PLMN ID selected by the UE (which is sent from the RAN to the AMF) to determine whether the UE expects roaming or non-roaming scenario.

In one embodiment, if the PLMN ID of the SUPI and the PLMN ID selected by the UE are the same, the AMF determines that the UE perceives the selected network as HPLMN. In such an embodiment, the AMF behaves as AMF in a HPLMN towards the UE.

If the PLMN ID of the SUPI and the PLMN ID selected by the UE are different, the AMF determines that the UE perceives the selected network as VPLMN. In such an embodiment, the AMF behaves as AMF in a VPLMN towards the UE.

FIG. 5 illustrates an indirect network sharing architecture, in accordance with aspects of the present disclosure. FIG. 5 shows two alternatives (Alternative A 502 and Alternative B 504, described below) for the indirect network sharing where the PLMN ID, which is broadcasted in shared RAN of the hosting network and which represents the participating network, is not the PLMN ID of the UE's SUPI.

In both Alternative A 502 and Alternative B 504, the UE selects the PLMN ID of the participating network as VPLMN ID, e.g., the UE perceives the selected network as VPLMN. In other words, the UE intends to register with the selected network (e.g., participating network) as if it registers to a VPLMN. From the network side, the hosting network performs VPLMN functionality towards the UE and towards the participating network; however, with the difference that the network slice configuration to the UE uses the S-NSSAIs of the participating network. The participating network may act as VPLMN towards the UE.

The difference between Alternative A 502 and Alternative B 504 is the deployment of the participating network. In Alternative A 502, the participating network and home network share the same core network (e.g. 5GC) 506. In Alternative B 504, the participating network 508 has a core network different from the core network of the home network 510.

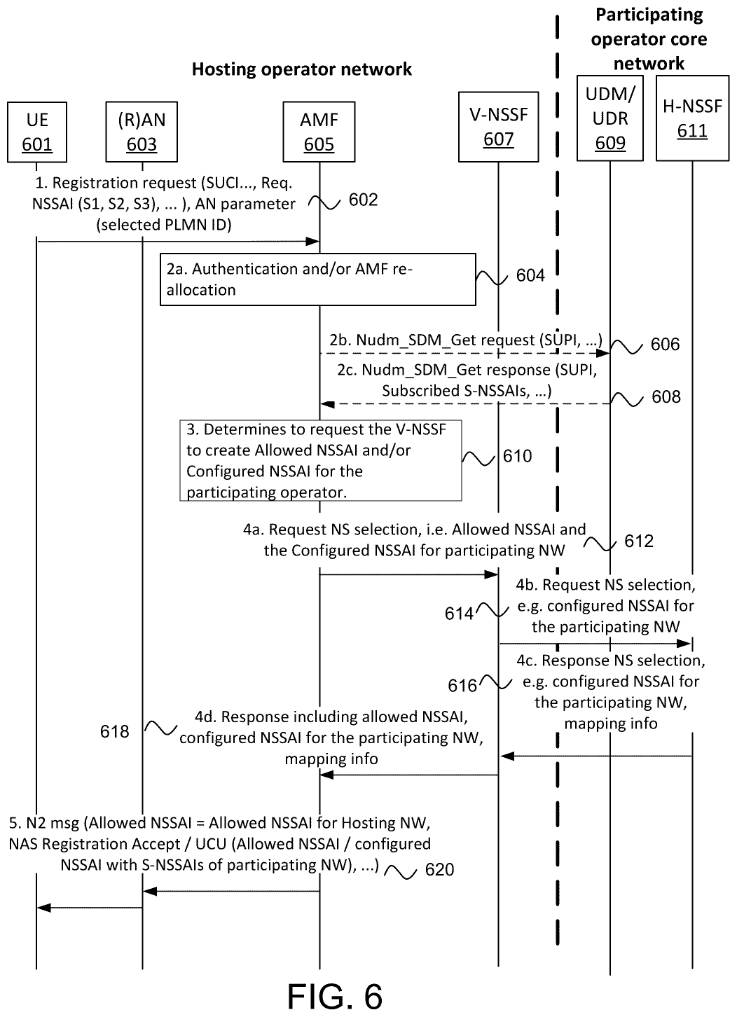

FIG. 6 illustrates an example signaling diagram for requesting network slice configuration information, in accordance with aspects of the present disclosure.

At 1 (see messaging 602), in one embodiment, the UE 601 selects a PLMN ID broadcasted by the cell of the shared RAN 603. The UE 601 creates and sends a registration request message included in access stratum radio resource control (RRC) signaling to the RAN node 603. The UE 601 also indicates the selected PLMN ID to the RAN node 603. The registration request message may include the Subscription Concealed Identifier (SUCI) and a requested NSSAI. In one example, the requested NSSAI may contain the S-NSSAI values S1, S2 and S3, e.g., of the participating network. The UE 601 may use locally stored configured NSSAI of the participating operator PLMN ID. The RAN node (e.g. gNB) 603 selects an AMF 605, creates an N2 message and sends the N2 message to the selected AMF 605. The AN parameters may include the selected PLMN ID as indicated by the UE 601.

At 2a (see block 604), in one embodiment, the AMF 605 determines, based on the indicated PLMN ID, that the UE 601 is registering to a participating network operator identified by the selected PLMN ID. In one embodiment, the SUCI includes the Home Network Identifier (HNI), and optionally the routing indicator, which are used by the AMF 605 to identify which network is the HPLMN and where the UDM 609 that stores or holds the UE 601 credentials is located. The HNI and the selected PLMN ID may identify different networks. If the UE 601 hasn't been authenticated yet, the AMF 605 may perform a primary authentication and authorization procedure.

If the AMF 605 selected by the RAN 603 doesn't support the functionality to perform registration of the UE 601 for the participating network, the AMF 605 may use an AMF redirection or re-allocation procedure to another AMF 605 that supports the serving AMF functionality in hosting network.

At 2b (see messaging 606), if the AMF 605 doesn't have the UE's subscription data, the AMF 605 selects a UDM 609 in the participating network and the AMF 605 requests from UDM 609 the UE subscription data. The AMF 605 may use the service operation Nudm_SDM_Get request and include the SUPI, which the AMF 605 may have obtained from the primary authentication and authorization procedure.

At 2c (see messaging 608), in one embodiment, the UDM 609 determines, e.g., based on the hosting PLMN ID, that the UE 601 is using indirect network sharing in the hosting network. The UDM 609 sends a response message including the UE Subscription data. The UDM 609 may derive a list of subscribed S-NSSAIs and or subscribed data network names (DNNs), which are applicable in case of indirect network sharing and/or in the specific hosting network. The UDM 609 may consider the service level agreement (SLA) between the participating operator and the hosting operator to derive the subscribed S-NSSAIs and/or DNNs to be sent in the UE subscription data.

At 3 (see block 610), in one embodiment, the AMF 605 determines that a UE 601 registering with a participating network and the AMF 605 determines whether the UE 601 is registering for roaming or for non-roaming case. Also, if the UE 601 does not provide a requested NSSAI in the registration request message, or the UE 601 indicates that the requested NSSAI is created based on the default configured NSSAI, the AMF 605 may determine that the UE 601 may need to be provided with configured NSSAI, in addition to allowed NSSAI or partially allowed NSSAI. If the UE 601 is registering in a non-roaming case, the AMF 605 may provide the configured NSSAI for the participating operator, whereas if the UE 601 is registering for a roaming case, the AMF 605 may provide both the configured NSSAI and the mapping of configured NSSAI for the participating network. In one embodiment, the configured NSSAI for the participating network contains S-NSSAIs of the participating network and the mapping of configured NSSAI for the participating network contains a mapping of the S-NSSAIs of the participating network to the S-NSSAIs of the HPLMN.

In one embodiment, because the AMF 605 may not have local configuration to create the configured NSSAI and the mapping of the configured NSSAI for the participating network, the AMF 605 may send a request to the V-NSSF to request the network slice configuration for the UE 601 and the AMF 605 may include one or more of an indication for the hosting network PLMN ID, an indication of the participating network PLMN ID, and an indication of the HPLMN ID (e.g., the PLMN ID of the UE's SUPI).

At 4a (see messaging 612), in one embodiment, the AMF 605 determines to send a request message to the V-NSSF to request a network slice configuration for the UE 601 for the hosting network and for the participating network. The AMF 605 may include at least one of a request indication for allowed NSSAI and configured NSSAI (and optionally the mapping of the configured NSSAI) for the participating network identified by the participating PLMN ID and/or a request indication for the S-NSSAIs of the hosting network corresponding to the S-NSSAIs included in the allowed NSSAI and/or configured NSSAI for the participating network.

In one embodiment, the AMF 605 may use the service operation Nnssf_NSSelection_Get request and may include one or more parameters, including the list of subscribed S-NSSAIs, requested NSSAI, current TAI(s), PLMN ID of the hosting network, the PLMN ID of the participating network, the PLMN ID of the HPLMN and/or the request indications from the previous paragraph.

At 4b (see messaging 614), in one embodiment, the NSSF of the hosting operator (e.g., V-NSSF 607) may determine the information requested in 4a using locally configured or stored information about the participating network slice configuration, e.g., based on SLA between the hosting operator and the participating operator. By this, the V-NSSF 607 may create the allowed NSSAI and configured NSSAI for the participating network (and optionally the mapping of the configured NSSAI) for the participating network and the rejected NSSAIs for the participating network (e.g., the S-NSSAIs not available or supported in the participating network) and optionally the mapping of the excluded or rejected S-NSSAI of the participating network to the HPLMN S-NSSAI. In such case, the V-NSSF 607 may proceed to 4d, e.g., the V-NSSF 607 doesn't need to request the NSSF in the participating network.

In another embodiment, the V-NSSF 607 may send a request to the H-NSSF 611 for the configured NSSAI for the participating network PLMN ID (shown at 4c in FIG. 6). The V-NSSF 607 may include in the request one or more of the following parameters: subscribed S-NSSAIs, requested NSSAI, participating PLMN ID, HPLMN ID, an indication that the configured NSSAI for the participating PLMN ID is required, an indication that the mapping of the S-NSSAIs of the subscribed S-NSSAIs (i.e. the HPLMN S-NSSAIs) to the (VPLMN) S-NSSAIs of the participating network is required.

At 4c (see messaging 616), in one embodiment, the NSSF of the participating operator (e.g. H-NSSF 611) determines, e.g. based on the subscribed S-NSSAIs and the local configuration for network slicing in the participating operator (e.g. availability of S-NSSAIs in the participating network), one or more of the configured NSSAI for the participating PLMN ID, in case the participating network acts as VPLMN for the UE, the mapping of the S-NSSAIs of the configured NSSAI of the participating operator to the subscribed S-NSSAIs (e.g., the H-PLMN S-NSSAIs), the excluded or rejected NSSAIs for the participating network (e.g., the S-NSSAIs not available or supported in the participating network) and optionally the mapping of the excluded or rejected S-NSSAI of the participating network to the HPLMN S-NSSAI. The H-NSSF 611 considers the subscribed S-NSSAIs of the UE 601 and the supported S-NSSAIs of the participating network.

In one embodiment, the H-NSSF 611 sends a response message to the V-NSSF 607 including one or more of the configured NSSAI for the participating PLMN ID and the mapping of the subscribed S-NSSAIs to the VPLMN S-NSSAIs of the participating network.

At 4d (see messaging 618), in one embodiment, the V-NSSF 607 determines the network slice configuration information for the AMF 605, which may include, based on the information received from the NSSF in the participating network, one or more of:
1) The allowed NSSAI for the UE 601 including the S-NSSAIs of the participating network. The V-NSSF 607 uses at least one of the subscribed S-NSSAIs, the received configured NSSAI for the UE 601 for the participating network, the mapping of the subscribed S-NSSAIs to the (VPLMN) S-NSSAIs of the participating network, and the mapping of the (VPLMN) S-NSSAIs of the participating network to the S-NSSAIs of the hosting network. The V-NSSF 607 may determine which S-NSSAIs of the hosting network are available/supported in the current UE's TAI. The V-NSSF 607 uses the available or supported S-NSSAIs of the hosting network and maps them to the S-NSSAIs of the participating network. The V-NSSF 607 may create the allowed NSSAI for the UE 601 by including the S-NSSAIs of the participating network (which correspond/map to the S-NSSAIs of the hosting network available/supported in the current TAI).
2) The configured NSSAI for the participating network (e.g. including S-NSSAIs of the participating network), which may have been created based on internal configuration in V-NSSF 607, and, if applicable, the mapping of the S-NSSAIs of the configured NSSAI of the participating network to the subscribed S-NSSAIs (i.e. the H-PLMN S-NSSAIs).
3) A list of mapped S-NSSAIs of the hosting network corresponding to the S-NSSAIs of the participating network included in the allowed NSSAI, and/or rejected S-NSSAIs. Such list may be referred to as the allowed NSSAI for the hosting network, e.g., the NSSAI containing S-NSSAI values of the hosting network mapping to the S-NSSAI values of the allowed NSSAI for the participating network. The allowed NSSAI for the hosting network (or partially allowed NSSAI for the hosting network) are used only internally in the hosting network. Optionally, the V-NSSF 607 may include the mapping information of the S-NSSAIs of the participating network (e.g., as included in the allowed NSSAI for the UE 601 for the participating network) to the S-NSSAIs of the hosting network.
4) List of one or more rejected S-NSSAIs of the participating network. The rejected S-NSSAIs of the participating network are those S-NSSAIs from the requested NSSAI (received at the V-NSSA in 4a), which cannot be served in the hosting network. The V-NSSF 607 can determine the list of one or more rejected S-NSSAIs of the participating operator by itself or the V-NSSF 607 uses the received information from the H-NSSF 611 in 4c, e.g., rejected NSSAIs for the participating network. In addition, the NSSF may provide the mapping of the rejected S-NSSAI of the participating network to the HPLMN S-NSSAI.

In one embodiment, the V-NSSF 607 sends a response message to the AMF 605 corresponding to the request from 4a. The response message may include one or more of the allowed NSSAI and the configured NSSAI for the participating network identified by the participating PLMN ID and/or the S-NSSAIs of the hosting network corresponding to the S-NSSAIs included in the allowed NSSAI and/or configured NSSAI for the participating network.

At 5 (see messaging 620), in one embodiment, the AMF 605 receives the network slice configuration information from the V-NSSF 607, as described in 4d. Based on the received information, the AMF 605 creates a registration area (RA) for the UE 601. The AMF 605 may create the allowed NSSAI, partially allowed NSSAI, rejected S-NSSAIs and/or S-NSSAIs partially rejected in the RA to be sent to the UE 601. The AMF 605 uses the configured NSSAI, as received in 4d, to provide the NAS message to the UE 601. If the UE 601 is registering for a roaming case, the AMF 605 also provides the mapping information of the S-NSSAIs included in the allowed NSSAI, partially allowed NSSAI, rejected S-NSSAIs, S-NSSAIs partially rejected in the RA, and/or the configured NSSAI. The mapping information for the foregoing may include the S-NSSAIs of the participating network to the HPLMN S-NSSAIs.

In one embodiment, the list of mapped S-NSSAIs of the hosting network corresponding to the S-NSSAIs of the participating network included in the allowed NSSAI and/or rejected S-NSSAI (e.g., the allowed NSSAI for the hosting network) is stored locally in AMF 605 and used for signalling to RAN 603 and other entities of the hosting network. The AMF 605 may also locally store the mapping information of the S-NSSAIs of the participating network (e.g., as included in the allowed NSSAI or configured NSSAI for the UE 601 for the participating network) to the S-NSSAIs of the hosting network.

In one embodiment, the AMF 605 may create registration area for the UE 601 and also determine partially allowed NSSAI, wherein the AMF 605 uses the information received in 4d. In one embodiment, the AMF 605 creates and sends a NAS registration accept message to the UE 601. The NAS registration accept message is encapsulated in N2 message to the RAN node 603. In one embodiment, the AMF 605 creates an N2 message and includes the Allowed NSSAI for hosting network to the RAN 603. This allows the RAN 603 to apply policy for cell selection and steering according to the S-NSSAIs of the hosting network.

In one embodiment, the NAS registration accept message includes one or more of the allowed NSSAI for the UE 601 and/or partially allowed NSSAI for the UE 601 (any of which having the S-NSSAIs of the participating network and in case of roaming UE the mapping of the allowed NSSAI for the UE 601 to the HPLMN S-NSSAI), a list of rejected S-NSSAIs where the S-NSSAI values are the S-NSSAIs of the participating network and in case of roaming UE the mapping of the rejected S-NSSAIs to the HPLMN S-NSSAIs, the configured NSSAI for the participating network and, in case of roaming UE, the mapping of the S-NSSAIs of the configured NSSAI of the participating network to the subscribed S-NSSAIs (i.e. the H-PLMN S-NSSAIs).

In one embodiment, the solutions described herein provide for the NSSF in the hosting network being able to provide (e.g., with the help of the NSSF of the participating network) to the AMF 605 one or more of the allowed NSSAI for the participating network, the configured NSSAI for the participating network, the mapping of the S-NSSAIs of the participating network to the S-NSSAIs of the hosting network, the rejected S-NSSAIs for the participating network, and the allowed NSSAI for the hosting network. By this, the AMF 605 is enabled to configure the UE 601 with the needed network slicing information for the participating network. Moreover, the AMF 605 may create the network slicing information applicable in the hosting network.

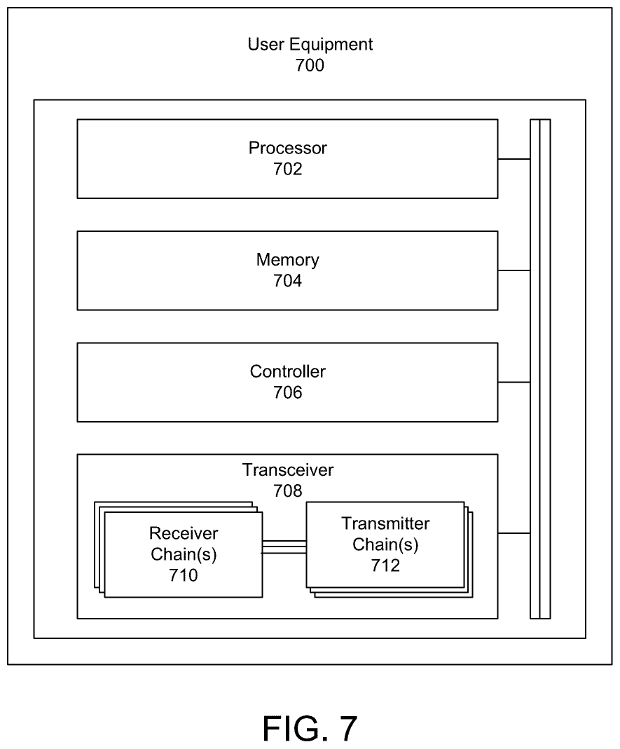

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding and processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

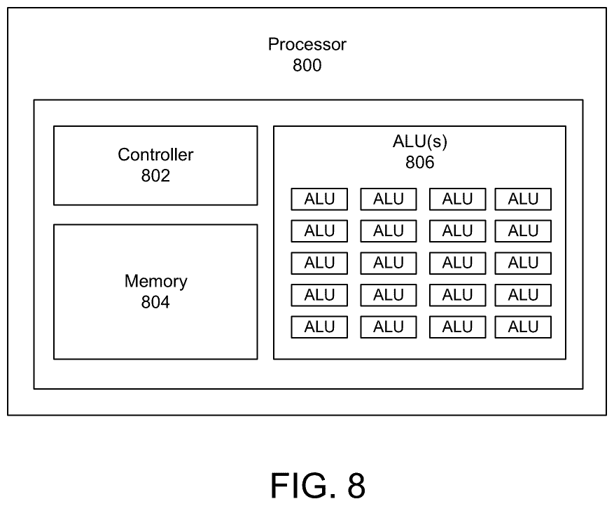

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. In one embodiment, the processor 800 may be configured to or operable to support a means to receive a first message from a second network entity of a hosting network to provide network slice configuration information for a UE of a participating network associated with the hosting network, wherein the first message comprises assistance information. In one embodiment, the processor 800 may be configured to support a means to transmit a second message to the second network entity comprising the network slice configuration information, wherein the network slice configuration information comprises one or more of an allowed NSSAI, a configured NSSAI, or a list of rejected S-NSSAIs, wherein the allowed NSSAI, the configured NSSAI, or the rejected S-NSSAIs comprise S-NSSAIs of the participating network.

In one embodiment, the assistance information of the first message comprises one or more of a list of subscribed S-NSSAIs, a requested NSSAI, a PLMN identifier for the hosting network, a PLMN identifier for the participating network, a tracking area, an indication of indirect network sharing, or a combination thereof.

In one embodiment, in response to not determining the network slice configuration information for the second message, the processor 800 may be configured to support a means to cause the network entity to transmit a third message to a third network entity of the participating network, the third message requesting the network slice configuration information of the participating network and comprising the assistance information received in the first message, and receive a fourth message from the third network entity of the participating network, the fourth message comprising the network slice configuration information for the UE of the participating network, wherein the network slice configuration information comprises one or more of a configured NSSAI for the participating network and mapping information for the S-NSSAIs of the configured NSSAI to the S-NSSAIs of the hosting network.

In one embodiment, the network entity comprises an NSSF of the hosting network, the second network entity comprising an AMF of the hosting network, and the third network entity comprises an NSSF of the participating network. In one embodiment, the processor 800 may be configured to support a means to determine the allowed NSSAI for the UE based on at least one of a subscribed NSSAI for the UE or the configured NSSAI for the UE received from the third network entity.

In one embodiment, the processor 800 may be configured to support a means to determine the allowed NSSAI, the configured NSSAI, and the list of rejected S-NSSAIs for the UE, wherein the allowed NSSAI, the configured NSSAI, or the list of rejected S-NSSAIs comprise at least one S-NSSAI of the participating network.

In one embodiment, in response to the UE roaming, the processor 800 may be configured to support a means to determine and transmit to the second network entity one or more of a mapping of the at least one S-NSSAI of the allowed NSSAI, the configured NSSAI, the list of rejected S-NSSAIs for the UE to at least one S-NSSAI of a home public land mobile network.

In one embodiment, the processor 800 may be configured to support a means to determine and transmit to the second network entity a list of mapped S-NSSAIs of the hosting network corresponding to S-NSSAIs included in the allowed NSSAI.

In one embodiment, in response to the UE roaming, the processor 800 may be configured to support a means to determine a mapping of a set of rejected S-NSSAIs of the participating network to at least one single NSSAI of a home public land mobile network.

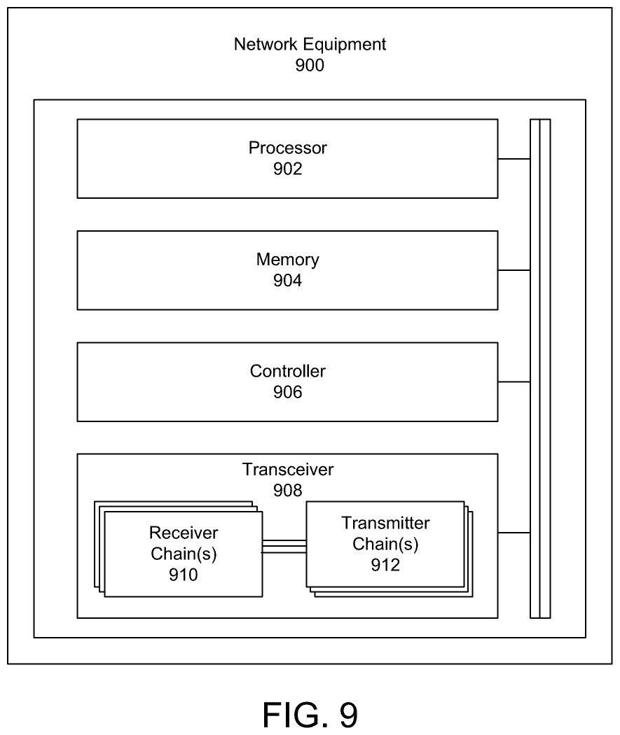

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The NE 900 may be configured to support a means to determine a NES mode for the NE, the NES mode comprising a DU-specific mode or an RU-specific mode of a distributed architecture, determine an NES class and an NES configuration for a traffic flow associated with the NE based on the NES mode, the NES class associated with a QoS class for the traffic flow, map the traffic flow to a DU, an RU, or a combination thereof based on the NES class associated with the traffic flow, and transmit the NES configuration to the DU, the RU, or the combination thereof mapped to the traffic flow.

In one embodiment, the NE 900 may be configured to support a means to receive a first message from a second network entity of a hosting network to provide network slice configuration information for a UE of a participating network associated with the hosting network, wherein the first message comprises assistance information. In one embodiment, the NE 900 may be configured to support a means to transmit a second message to the second network entity comprising the network slice configuration information, wherein the network slice configuration information comprises one or more of an allowed NSSAI, a configured NSSAI, or a list of rejected S-NSSAIs, wherein the allowed NSSAI, the configured NSSAI, or the rejected S-NSSAIs comprise S-NSSAIs of the participating network.

In one embodiment, the assistance information of the first message comprises one or more of a list of subscribed S-NSSAIs, a requested NSSAI, a PLMN identifier for the hosting network, a PLMN identifier for the participating network, a tracking area, an indication of indirect network sharing, or a combination thereof.

In one embodiment, in response to not determining the network slice configuration information for the second message, the NE 900 may be configured to support a means to cause the network entity to transmit a third message to a third network entity of the participating network, the third message requesting the network slice configuration information of the participating network and comprising the assistance information received in the first message, and receive a fourth message from the third network entity of the participating network, the fourth message comprising the network slice configuration information for the UE of the participating network, wherein the network slice configuration information comprises one or more of a configured NSSAI for the participating network and mapping information for the S-NSSAIs of the configured NSSAI to the S-NSSAIs of the hosting network.

In one embodiment, the network entity comprises an NSSF of the hosting network, the second network entity comprising an AMF of the hosting network, and the third network entity comprises an NSSF of the participating network. In one embodiment, the NE 900 may be configured to support a means to determine the allowed NSSAI for the UE based on at least one of a subscribed NSSAI for the UE or the configured NSSAI for the UE received from the third network entity.

In one embodiment, the NE 900 may be configured to support a means to determine the allowed NSSAI, the configured NSSAI, and the list of rejected S-NSSAIs for the UE, wherein the allowed NSSAI, the configured NSSAI, or the list of rejected S-NSSAIs comprise at least one S-NSSAI of the participating network.

In one embodiment, in response to the UE roaming, the NE 900 may be configured to support a means to determine and transmit to the second network entity one or more of a mapping of the at least one S-NSSAI of the allowed NSSAI, the configured NSSAI, the list of rejected S-NSSAIs for the UE to at least one S-NSSAI of a home public land mobile network.

In one embodiment, the NE 900 may be configured to support a means to determine and transmit to the second network entity a list of mapped S-NSSAIs of the hosting network corresponding to S-NSSAIs included in the allowed NSSAI.

In one embodiment, in response to the UE roaming, the NE 900 may be configured to support a means to determine a mapping of a set of rejected S-NSSAIs of the participating network to at least one single NSSAI of a home public land mobile network.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 causes the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding and processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

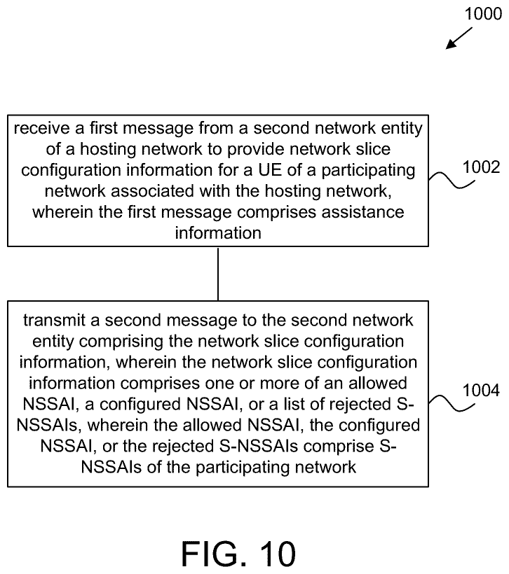

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may receive a first message from a second network entity of a hosting network to provide network slice configuration information for a UE of a participating network associated with the hosting network, wherein the first message comprises assistance information. The operations of 1002 may be performed in accordance with examples as described herein. In some implementations, aspects of the operations of 1002 may be performed by the NE as described with reference to FIG. 9.

At 1004, the method may transmit a second message to the second network entity comprising the network slice configuration information, wherein the network slice configuration information comprises one or more of an allowed NSSAI, a configured NSSAI, or a list of rejected S-NSSAIs, wherein the allowed NSSAI, the configured NSSAI, or the rejected S-NSSAIs comprise S-NSSAIs of the participating network. The operations of 1004 may be performed in accordance with examples as described herein. In some implementations, aspects of the operations of 1004 may be performed by the NE as described with reference to FIG. 9.

It should be noted that the method described herein describes a possible implementation, and that the operations and the steps may be rearranged or otherwise modified and that other implementations are possible.

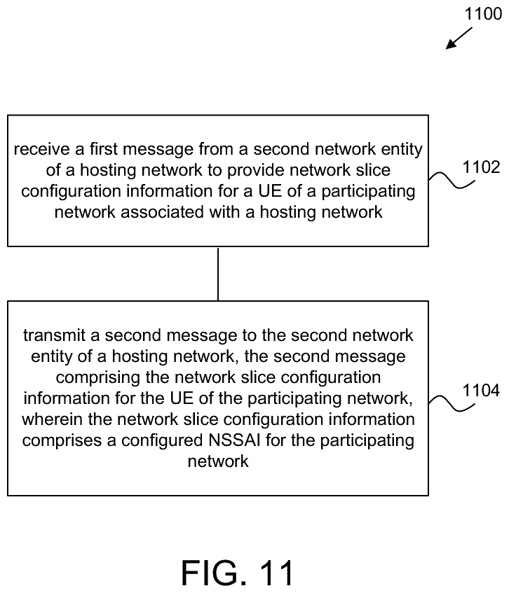

FIG. 11 illustrates a flowchart of a method in accordance with aspects of the present disclosure. The operations of the method may be implemented by an NE as described herein. In some implementations, the NE may execute a set of instructions to control the function elements of the NE to perform the described functions.

At 1102, the method may receive a first message from a second network entity of a hosting network to provide network slice configuration information for a UE of a participating network associated with a hosting network. The operations of 1102 may be performed in accordance with examples as described herein. In some implementations, aspects of the operations of 1102 may be performed by the NE as described with reference to FIG. 9.

At 1104, the method may transmit a second message to the second network entity of a hosting network, the second message comprising the network slice configuration information for the UE of the participating network, wherein the network slice configuration information comprises a configured NSSAI for the participating network. The operations of 1104 may be performed in accordance with examples as described herein. In some implementations, aspects of the operations of 1104 may be performed by the NE as described with reference to FIG. 9.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
at least one memory; and
at least one processor coupled with the at least one memory and configured to cause the network entity to:
receive a first message from a second network entity of a hosting network to provide network slice configuration information for a user equipment (UE) of a participating network associated with the hosting network, wherein the first message comprises assistance information; and
transmit a second message to the second network entity comprising the network slice configuration information, wherein the network slice configuration information comprises one or more of an allowed network slice selection assistance information (NSSAI), a configured NSSAI, or a list of rejected single NSSAIs (S-NSSAIs), wherein the allowed NSSAI, the configured NSSAI, or the rejected S-NSSAIs comprise S-NSSAIs of the participating network.

2. The network entity of claim 1, wherein:
the assistance information of the first message comprises one or more of a list of subscribed S-NSSAIs, a requested NSSAI, a public land mobile network (PLMN) identifier for the hosting network, a PLMN identifier for the participating network, a tracking area, an indication of indirect network sharing, or a combination thereof.

3. The network entity of claim 1, wherein, in response to not determining the network slice configuration information for the second message, the at least one processor is configured to cause the network entity to:
transmit a third message to a third network entity of the participating network, the third message requesting the network slice configuration information of the participating network and comprising the assistance information received in the first message; and
receive a fourth message from the third network entity of the participating network, the fourth message comprising the network slice configuration information for the UE of the participating network, wherein the network slice configuration information comprises one or more of a configured NSSAI for the participating network and mapping information for the S-NSSAIs of the configured NSSAI to the S-NSSAIs of the hosting network.

4. The network entity of claim 3, wherein:
the network entity comprises a network slice selection function (NSSF) of the hosting network, the second network entity comprising an access and mobility management function (AMF) of the hosting network, and the third network entity comprises an NSSF of the participating network.

5. The network entity of claim 3, wherein the at least one processor is configured to cause the network entity to:
determine the allowed NSSAI for the UE based on at least one of a subscribed NSSAI for the UE or the configured NSSAI for the UE received from the third network entity.

6. The network entity of claim 1, wherein the at least one processor is configured to cause the network entity to:
determine the allowed NSSAI, the configured NSSAI, and the list of rejected S-NSSAIs for the UE, wherein the allowed NSSAI, the configured NSSAI, or the list of rejected S-NSSAIs comprise at least one S-NSSAI of the participating network.

7. The network entity of claim 6, wherein, in response to the UE roaming, the at least one processor is configured to cause the network entity to:
determine and transmit to the second network entity one or more of a mapping of the at least one S-NSSAI of the allowed NSSAI, the configured NSSAI, the list of rejected S-NSSAIs for the UE to at least one S-NSSAI of a home public land mobile network.

8. The network entity of claim 1, wherein the at least one processor is configured to cause the network entity to:
determine and transmit to the second network entity a list of mapped S-NSSAIs of the hosting network corresponding to S-NSSAIs included in the allowed NSSAI.

9. The network entity of claim 8, wherein, in response to the UE roaming, the at least one processor is configured to cause the network entity to:
determine a mapping of a set of rejected S-NSSAIs of the participating network to at least one single NSSAI of a home public land mobile network.

10. A processor for wireless communication, comprising:
at least one controller coupled with at least one memory and configured to cause the processor to:
receive a first message from a second network entity of a hosting network to provide network slice configuration information for a user equipment (UE) of a participating network associated with the hosting network, wherein the first message comprises assistance information; and
transmit a second message to the second network entity comprising the network slice configuration information, wherein the network slice configuration information comprises one or more of an allowed network slice selection assistance information (NSSAI), a configured NSSAI, or a list of rejected single NSSAIs (S-NSSAIs), wherein the allowed NSSAI, the configured NSSAI, or the rejected S-NSSAIs comprise S-NSSAIs of the participating network.

11. The processor of claim 10, wherein:
the assistance information of the first message comprises one or more of a list of subscribed S-NSSAIs, a requested NSSAI, a public land mobile network (PLMN) identifier for the hosting network, a PLMN identifier for the participating network, a tracking area, an indication of indirect network sharing, or a combination thereof.

12. The processor of claim 10, wherein, in response to not determining the network slice configuration information for the second message, the at least one controller is configured to cause the processor to:
transmit a third message to a third network entity of the participating network, the third message requesting the network slice configuration information of the participating network and comprising the assistance information received in the first message; and
receive a fourth message from the third network entity of the participating network, the fourth message comprising the network slice configuration information for the UE of the participating network, wherein the network slice configuration information comprises one or more of a configured NSSAI for the participating network and mapping information for the S-NSSAIs of the configured NSSAI to the S-NSSAIs of the hosting network.

13. The processor of claim 12, wherein:
the network entity comprises a network slice selection function (NSSF) of the hosting network, the second network entity comprising an access and mobility management function (AMF) of the hosting network, and the third network entity comprises an NSSF of the participating network.

14. The processor of claim 12, wherein the at least one controller is configured to cause the processor to:
determine the allowed NSSAI for the UE based on at least one of a subscribed NSSAI for the UE or the configured NSSAI for the UE received from the third network entity.

15. The processor of claim 10, wherein:
the assistance information of the first message comprises one or more of a list of subscribed S-NSSAIs, a requested NSSAI, a public land mobile network (PLMN) identifier for the hosting network, a PLMN identifier for the participating network, a tracking area, an indication of indirect network sharing, or a combination thereof.

16. A method performed by a network entity, the method comprising:
receiving a first message from a second network entity of a hosting network to provide network slice configuration information for a user equipment (UE) of a participating network associated with the hosting network, wherein the first message comprises assistance information; and
transmitting a second message to the second network entity comprising the network slice configuration information, wherein the network slice configuration information comprises one or more of an allowed network slice selection assistance information (NSSAI), a configured NSSAI, or a list of rejected single NSSAIs (S-NSSAIs), wherein the allowed NSSAI, the configured NSSAI, or the rejected S-NSSAIs comprise S-NSSAIs of the participating network.

17. A network entity, comprising:
at least one memory; and
at least one processor coupled with the at least one memory and configured to cause the network entity to:
receive a first message from a second network entity of a hosting network to provide network slice configuration information for a user equipment (UE) of a participating network associated with a hosting network; and
transmit a second message to the second network entity of a hosting network, the second message comprising the network slice configuration information for the UE of the participating network, wherein the network slice configuration information comprises a configured network slice selection assistance information (NSSAI) for the participating network.

18. The network entity of claim 17, wherein:
the network entity comprises a network slice selection function (NSSF) of the participating network and the second network entity comprises NSSF of the hosting network.

19. The network entity of claim 17, wherein:
the second message comprises a mapping of single NSSAIs of the configured NSSAI of the participating network to subscribed single NSSAIs.

20. The network entity of claim 19, wherein the at least one processor is configured to cause the network entity to:
determine the configured NSSAI for the participating network and the mapping of single NSSAIs of the configured NSSAI of the participating network to subscribed single NSSAIs based on the subscribed single NSSAIs of the UE, the single NSSAIs of the participating network corresponding to the subscribed single NSSAIs, supported single NSSAIs of the participating network, or a combination thereof.
